(19) United States
(12) Patent Application Publication
(10) Pub. No.: US 2006/0012893 A1
(43) Pub. Date: Jan. 19, 2006

(54) Objective, in particular a projection objective in microlithography

(76) Inventors: Ulrich Weber, Ulm (DE); Alexander Kohl, Aalen (DE); Hubert Holderer, Oberkochen (DE)

Correspondence Address: WELLS ST. JOHN P.S., 601 W. FIRST AVENUE, SUITE 1300, SPOKANE, WA, 99201, US

(21) Appl. No.: 10/530,689

(22) PCT Filed: Aug. 13, 2003
(86) PCT No.: PCT/EP03/08962

§ 371 Date: Apr. 7, 2005

(30) Foreign Application Priority Data
Oct. 8, 2002 (DE) 102 46 828.1

(51) Int. Cl. G02B 7/02

(52) U.S. Cl. 359/819

(57) ABSTRACT

An objective, in particular a projection objective in microlithography for producing semiconductor components, is assembled from a number of individual housing structures (4, 5), optical elements being arranged in each housing structure (4, 5), and a number of optical axes (15, 16, 18, 35) being formed by the housing structures (4, 5). At least one first housing structure (4) is provided with seats (22, 23, 24, 25) on which one or more further housing structures (5) and/or optical subassemblies (6, 8, 11, 14) are adjusted and are connected to the first housing structure (4).

### BACKGROUND OF THE INVENTION

1. Field of the Invention

The invention relates to an objective, in particular a projection objective in microlithography for producing semiconductor components, that is assembled from a number of individual housing structures, optical elements being arranged in each housing structure, and a number of optical axes being formed by the housing structures. The invention also refers to a housing for a projection lens used for microlithography with adjusting surface for mounting and adjusting said housing.

2. Description of the Related Art

Objectives of the type mentioned at the beginning are described, for example, in U.S. Pat. No. 6,043,863 and U.S. Pat. No. 6,195,213 B1. A system for measuring a projection objective with reference surfaces is described in the older German P 101 36 388.5.

As EP 1 168 028 A2 discloses a projection objective that is assembled from a number of individual housing structures having optical elements. The adaptation and/or assignment of the housing structures to one another is performed in this case by means of an auxiliary optical system through the focus. Use is made in this case of interferometers for adjusting distances and lengths, and of autocollimation telescopes for adjusting angles.

For reasons of space, but also because of specific optical elements such as, for example, deflecting mirrors and beam splitter elements, owing to folding of the optical beam path such objectives exhibit by contrast with a simple refractive objective a number of optical axes that sometimes run perpendicular, and sometimes parallel to one another. The individual optical axes are formed in this case by various objective parts and/or housing structures.

There are problems in this case with adjusting the individual optical axes exactly to one another with the required high accuracy, in particular so that they run exactly parallel or perpendicular to one another. To be precise, such objectives frequently have no common objective housing, but are assembled from a number of individual housing structures.

### SUMMARY OF THE INVENTION

It is therefore the object of the present invention to provide an objective of the type mentioned at the beginning, it being possible for the individual housing structures to be adjusted exactly to one another with reference to their optical axes, and the aim being for it also to be possible in case of need to readjust individual housing structures and/or optical subassemblies and individual optical elements.

This object is achieved according to the invention by virtue of the fact that at least one first housing structure is provided with seats on which one or more further housing structures are adjusted and are connected to said first housing structure.

According to the invention, a housing structure of the objective is selected that forms the core of the assembled objective or serves as “central” housing structure about which the remaining housing structures are then grouped. Here, the “central” housing structure has the required seats, and so appropriately accurate adjusting and mounting can be performed, the adjusting and alignment of the remaining housing structures that are connected to the “central” housing structure being oriented with reference to their optical axes to the seats and to the optical axis of the “central” housing structure.

The result of these measures is that the individual optical axes can be aligned very accurately with one another, readjustments also being possible in case of need.

In an advantageous refinement of the invention, the seats can also serve simultaneously for adjusting optical subassemblies or individual components that are installed in the housing structure provided with seats, or are to be fitted thereon.

For mounting reasons and also to facilitate the adjustment method, external surfaces on the first housing structure are generally provided as seats.

According to the invention, it can be provided in this case that provided as external surfaces is at least one first seat that runs at an angle of less than 30°, for example parallel, to a first optical axis.

It can be provided in addition that two mutually parallel seats and seats parallel to a first optical axis are provided as further external surfaces, it being possible for the first seat to be arranged at least approximately perpendicular, or at an angle of greater than 60° to the mutually parallel seats.

When the housing structure provided with the seats is also provided with one or more deflecting mirrors for deflecting the optical axis, it can be provided that a fourth seat is provided at an angle to the first seat and to the two mutually parallel seats. The angle can in this case be at least approximately 45°, as a result of which the optical axis is deflected by at least approximately 90°.

In a very advantageous development of the invention, it can be provided that the second housing structure is provided with at least one seat on which one or more further optical elements arranged in substructures, or subassemblies of optical elements are adjusted and connected to the second housing structure.

It can be provided in this case, furthermore, that the second housing structure is provided with at least one further seat by means of which the first housing structure is connected to the second housing structure. This can be performed, for example, by respectively providing a seat of the first housing structure and of the second housing structure at the joint between the first housing structure and the second housing structure.

Advantageous developments and refinements of the invention emerge from the following exemplary embodiment described in principle with the aid of the drawings.

### BRIEF DESCRIPTION OF THE DRAWINGS

FIG. 1 shows an overall illustration of a projection objective according to the invention,

FIG. 2 shows an illustration of the first “central” housing structure with seats,

FIG. 3 shows an illustration of a second housing structure provided with seats, and

FIG. 4 shows a diagram in principle of a further projection objective of different design.

### DETAILED DESCRIPTION

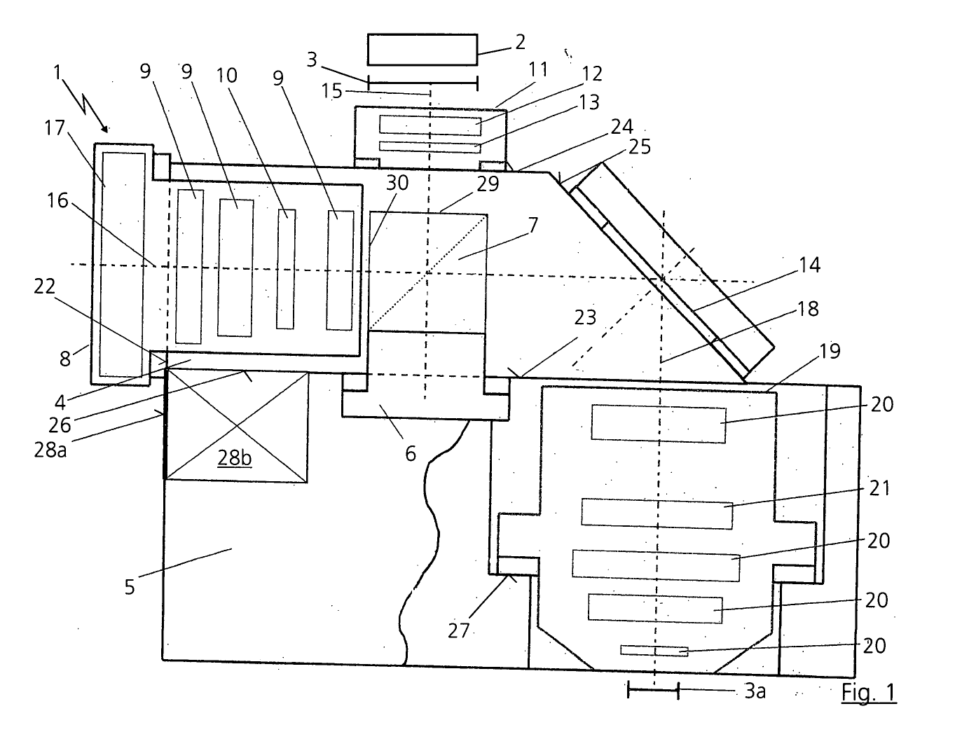

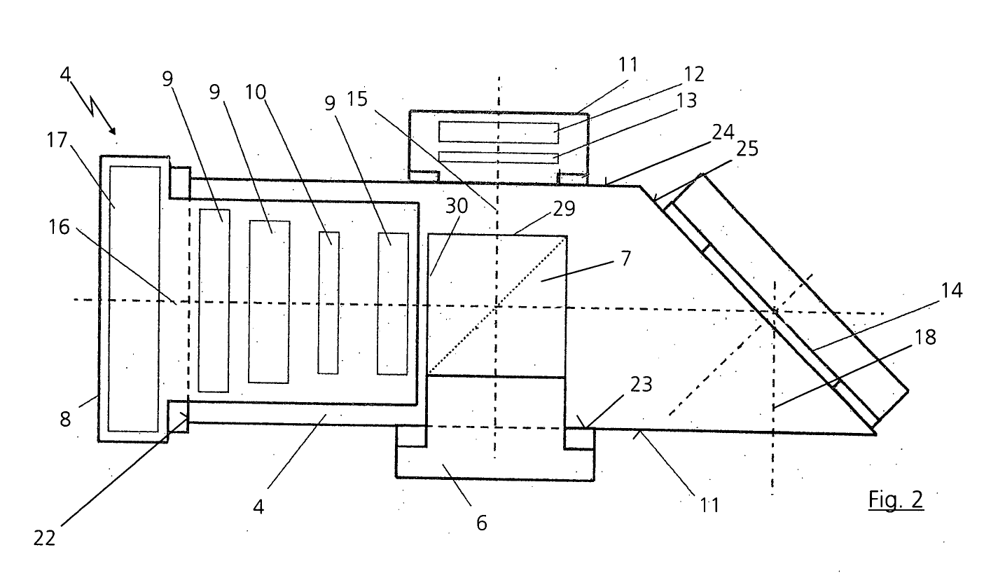

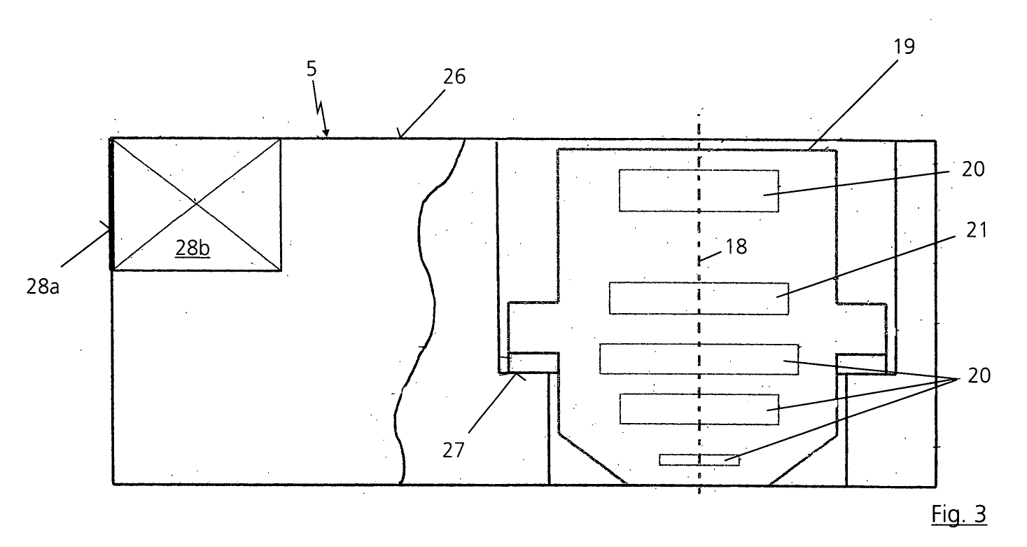

The objective to be seen in FIGS. 1 to 3 constitutes a projection objective 1 in a projection exposure machine having an exposure system 2 that includes a laser as light source, for example with a light-emitting wavelength smaller than 360 nm (not illustrated) and a reticle 3 that is arranged in the object plane and whose structure is depicted in greatly reduced form on a wafer 3a that is arranged downstream of the projection objective 1 in the beam direction.

The structure and mode of operation of the projection objective 1 are generally known, for which reason no further detail will be given in the following text except to refer by way of example in this respect to U.S. Pat. No. 6,043,863 and to U.S. Pat. No. 6,195,213 B1.

The objective 1 is formed from two individual housing structures, more specifically a first “central” housing structure 4 and a second housing structure 5. In addition, various optical subassemblies are integrated or fitted in the objective 1. A central element here is a subassembly 6 having a mount for a beam splitter element 7 in the form of a cube. The beam splitter element 7 produces a number of individual optical axes that run in general perpendicular or parallel to one another.

A precondition for an objective of very high imaging accuracy is that the individual optical axes be adjusted exactly relative to one another, that they meet one another with sufficient accuracy and run accurately enough parallel or at an exact angle, in general perpendicular to one another. This purpose is served by the first housing structure 4 with a number of seats for adjusting and centering the second housing structure 5 and diverse optical subassemblies such as, for example, the subassembly 6 with the beam splitter element 7. The first housing structure 4 is provided with a horizontally dipping optical subassembly 8 having a number of lenses 9 and a lambda/4 plate 10, with a first fitted optical subassembly 11 having one or more lenses 12 and a lambda/4 plate 13, and with a deflecting mirror 14.

The objective has a first optical axis 15 that runs in a vertical direction in the exemplary embodiment, and a second optical axis 16 that lies perpendicular to the first optical axis 15, runs in a horizontal direction and is caused by the beam splitter element 7. The beam path formed by the laser in the illuminating system 2 and having the first optical axis 15 is deflected at the beam splitter element 7 in a horizontal direction with the optical axis 16. Use is made in this case of the polarization of the incident light and of the property of beam splitter cubes to transmit p-polarized light and to reflect s-polarized light at 90°. After passage through the subassembly 8 with the lenses 9 and the lambda/4 plate 10, the beams are reflected at a concave mirror 17 which is likewise integrated in the optical subassembly 8. The lambda/4 plate 10 lying in the beam path rotates the polarization such that when it impinges again on the beam splitter element 7 the light beam can penetrate the latter. Subsequently, the beams are deflected from the horizontal direction at the deflecting mirror 14 into the vertical direction with a third optical axis 18. The beams strike the wafer 3a after passing through the second housing structure 5, in which there is installed a further optical subassembly 19 having a number of lenses 20 and a further lambda/4 plate 21.

The first housing structure 4 has a first seat 22 on the left-hand side. The first seat 22 in the exemplary embodiment shown is exactly perpendicular to a flat underside of the housing structure 4 with a second seat 23 and an upper third seat 24, running exactly parallel thereto, of the housing structure 4. In order to obtain an appropriately high imaging accuracy of the objective 1, it must be ensured that the seats 23 and 24 run as parallel to one another as possible and that the seat 22 is exactly perpendicular thereto in the exemplary embodiment shown.

The deflecting mirror 14 is seated on a further seat 25, which lies at an angle to the optical axis 16 that is 45° in the exemplary embodiment. This angle must likewise be fabricated with very high accuracy.

The second housing structure 5 has an upper bearing face for the first housing structure 4. For this reason, it is likewise designed as a seat 26 that is constructed to be exactly parallel to a seat 27 in the second housing structure 5, and that serves as locating surface for the optical subassembly 19.

It is important for mounting the objective that the stringent requirements for the accuracy of the position of the optical axes are substantially transferred to the position of the seat of the core housing structure 4 so that in the course of the adjustment it is essentially only the optical subassemblies that need be displaced in parallel along the seats of the core housing structure 4.

Further details on an exemplary mode of procedure are described in the old German P 101 36 388.5, which therefore also forms the disclosure content for the application present here.

The beam splitter element 7 is aligned via an input surface 29 and an output surface 30, directed toward the seat 22, in such a way that the input surface 29 lies exactly parallel to the seat 22. The alignment of the position of the optical axis 18 in relation to the lateral seats 28a and 28b, which are arranged on the second housing structure 5, takes place in cooperation with the seat 27, which is fabricated to be exactly perpendicular to the seat 26, while the seat 28b is fabricated to be exactly perpendicular to the seat 28a and to the seat 26.

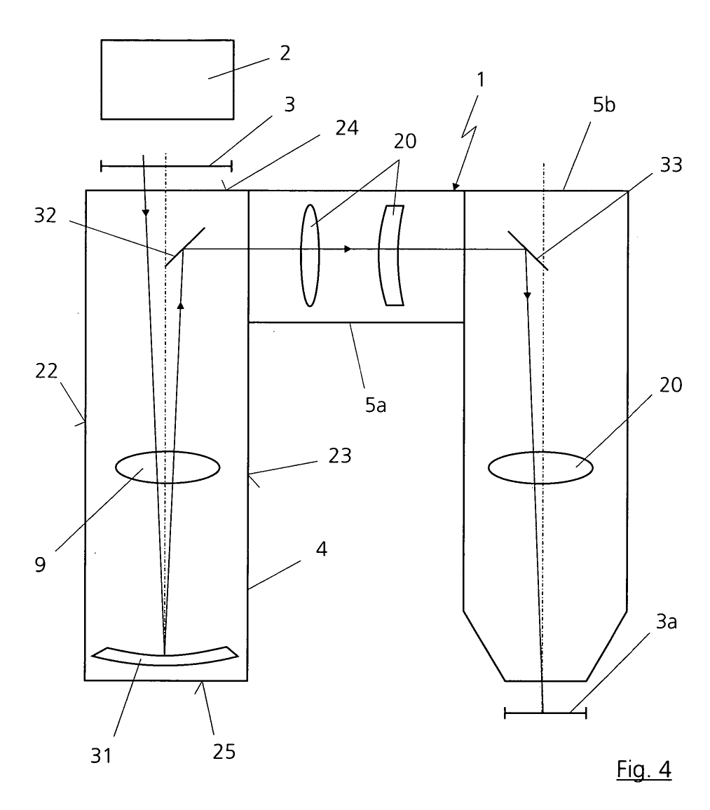

FIG. 4 describes the principle of a projection objective 1 with seats corresponding to the seats according to FIGS. 1 to 3. For the sake of simplification, the same reference numerals were used for parts that are the same or act in the same way. The projection objective according to FIG. 4 is an objective in a so-called H-design, a first housing structure 4 likewise being arranged downstream of the reticle 3. Two further housing structures 5a and 5b are connected to the housing structure 4, the housing structure 5a forming the connection between the housing structures 4 and 5b, which are aligned parallel to one another. A first deflection of the input beam is performed at a concave mirror 31 at the lower end, averted from the reticle 3, of the housing structure 4. The beam path reflected by the concave mirror 31 is diverted at a deflecting mirror 32 of the housing structure 4 into the housing structure 5a lying perpendicular thereto. A further deflecting mirror 33 in the housing structure 5b ensures that the beam path is deflected again by 90° and that the optical axis therefore once again runs parallel to the optical axis in the housing structure 4.

In the case of the projection objective according to FIG. 4, the housing structure 4 serves as central structure, and is correspondingly provided for this purpose with external seats 22, 23, 24 and 25, to which the housing structures 5a and 5b and, if appropriate, further optical components and subassemblies are aligned.

It goes without saying that the configuration according to the invention can also be used in the case of other configurations of projection objectives such as, for example projection objectives of Schwarzschild design in which mirrors for chromatic correction are situated opposite one another, and the beam path runs through the central openings of the mirrors.

It is possible in a similar way for the invention also to be used with a design that is modified by comparison with the H-design projection objective 1 according to FIG. 4, the deflecting mirrors being grouped together to form a prism.

Of course, the invention is suitable not only for adapting and adjusting two optical axes, but also for adapting and adjusting a number of optical axes.

The sequence of the mounting and adjusting in relation to the external surfaces is arbitrary and is governed by the respective application. Thus, for example, it is possible to undertake serial mounting. Assembly in groups is also likewise possible.

What is claimed is:

1. An objective, which is assembled from a number of individual housing structures, optical elements being arranged in each housing structure, wherein at least one first housing structure is provided with seats on which one or more further housing structures are adjusted and are connected to said first housing structure.

2. The objective according to claim 1, wherein at least one of said seats are provided for the purpose of adjusting and mounting of at least one optical element or optical subassembly in said first housing structure.

3. The objective according to claim 1, wherein the objective is a projection objective in microlithography for producing semiconductor components.

4. The objective according to claim 1, wherein a number of optical axes being formed by said housing structures.

5. The objective according to claim 1, wherein said seats are provided on external surfaces of said first housing structure.

6. The objective according to claim 5, wherein provided as said external surfaces is at least one first seat that runs at an angle of (<) less than 30°, in particular at least approximately parallel, to a first optical axis.

7. The objective according to claim 6, wherein provided as said further external surfaces are two mutually parallel seats which lie at an angle of (<) less than 30°, in particular at least approximately parallel, to a further optical axis.

8. The objective according to claim 6, wherein said first seat is arranged at least approximately perpendicular, at an angle of (>) greater than 60° to the mutually parallel seats.

9. The objective according to claim 7, wherein a fourth seat is provided at an angle to said first seat and to the two mutually parallel seats.

10. The objective according to claim 9, wherein said fourth seat is arranged at an angle of 45°±15 to the first seat and to said two mutually parallel seats, and wherein arranged on said fourth seat is a deflecting mirror for producing a third optical axis for a second housing structure.

11. The objective according to claim 8, wherein said second housing structure is provided with at least one seat on which one or more further optical elements arranged in substructures, or subassemblies of optical elements are adjusted and connected to said second housing structure.

12. The objective according to claim 10, wherein said second housing structure is provided with at least one further seat, wherein said at least one further seat connects said first housing structure with said second housing structure.

13. The objective according to claim 12, wherein the junction between said first housing structure and said second housing structure is formed by the seats of said first housing structure and of said second housing structure.

14. The objective according to claim 12, wherein said second housing structure is provided with at least two further seats, one seat running perpendicular to the seat, and the further seat running perpendicular to the further seat and to the seat via which said second housing structure is connected to said first housing structure.

15. A projection exposure machine for producing semiconductor components, comprising an objective according to claim 1.

16. The projection exposure machine for producing semiconductor components according to claim 15, for using light with a wavelength of less than 360 nm.
